(19) United States
(12) Patent Application Publication
(10) Pub. No.: US 2026/0316478 A1
(43) Pub. Date: Oct. 15, 2026

(54) FILM TO WHICH TRANSFER HAS BEEN COMPLETED AND PRODUCTION METHOD FOR FILM TO WHICH TRANSFER HAS BEEN COMPLETED

(71) Applicants: BROTHER KOGYO KABUSHIKI KAISHA, Nagoya-shi, Aichi (JP); General Co., Ltd., Osaka-shi, Osaka (JP)

(72) Inventors: Satoru ITO, Nagoya-shi, Aichi (JP); Masaya FUJITA, Nagoya-shi, Aichi (JP); Mina KATAOKA, Nagoya-shi, Aichi (JP); Haruki MATSUMOTO, Nagoya-shi, Aichi (JP); Yuki HOKARI, Nagoya-shi, Aichi (JP); Hiroaki NARUSE, Osaka-shi, Osaka (JP); Jiro HIRANO, Osaka-shi, Osaka (JP)

(73) Assignees: BROTHER KOGYO KABUSHIKI KAISHA, Nagoya-shi, Aichi (JP); General Co., Ltd., Osaka-shi, Osaka (JP)

(21) Appl. No.: 19/101,154

(22) PCT Filed: Aug. 2, 2023
(86) PCT No.: PCT/JP2023/028228

§ 371 Date: Feb. 4, 2025

(30) Foreign Application Priority Data
Aug. 5, 2022 (JP) 2022-125297

(51) Int. Cl. B41M 5/382

(52) U.S. Cl. CPC B41M 5/38228

(57) ABSTRACT

A transfer-completed film is a transfer-completed film with a transparent film, a laminated body of a first ink layer and a second ink layer having a different color than the first ink layer, and a base material layer laminated in this order, in which the first ink layer and the second ink layer form a transfer layer transferred with an ink ribbon that includes the laminated body of the first ink layer and the second ink layer. The transfer layer may be formed by hot-melt transfer. The laminated body of the first ink layer and the second ink layer includes a front surface side ink layer that is close to the transparent film and a back surface side ink layer opposite thereto, and the transparent film may be thicker than the front surface side ink layer.

### RELATED APPLICATION(S)

This application corresponds to Japanese Patent Application No. 2022-125297 filed in the Japan Patent Office on Aug. 5, 2022, the disclosure of which is incorporated herein by reference in its entirety.

### TECHNICAL FIELD

The disclosure relates to a transfer-completed film in which a transfer layer including at least two ink layers having colors different from each other is recorded, and a method of producing the same.

### BACKGROUND ART

Patent Literature 1 discloses a transfer sheet printing device including a supply unit for a first sheet with a dissolution layer and a seal layer laminated on a base material sheet, printing means that prints a figure and/or a character on a surface of the seal layer of the supplied first sheet, a supply unit for a second sheet with an adhesive layer and a peel-off sheet laminated on a cover sheet, peeling means that peels off the peel-off sheet with the adhesive layer adhering thereto from the cover sheet of the supplied second sheet, and sticking means that sticks the surface of the peel-off sheet, peeled off by the peeling means, on which the adhesive layer is formed and the surface of the first sheet on which the printing is performed for each other with the adhesive layer therebetween.

### CITATION LIST

### Patent Literature

Patent Literature 1: Japanese Patent Application Publication No. 11-170663

### SUMMARY OF INVENTION

### Technical Problem

A preferred embodiment of the disclosure provides a transfer-completed film in which a transfer layer including a laminated body of at least two ink layers having colors different from each other is recorded, in which an end portion color of the ink layer that is hidden by the front surface side ink layer can be made less likely to be observed, and a method of producing the same.

### Solution to Problem

A transfer-completed film according to a preferred embodiment of the disclosure is a transfer-completed film with a transparent film, a laminated body of a first ink layer and a second ink layer having a different color than the first ink layer, and a base material layer laminated in this order, in which the first ink layer and the second ink layer form a transfer layer transferred with an ink ribbon that includes a laminated body of the first ink layer and the second ink layer.

### Advantageous Effects of Invention

In accordance with the transfer-completed film according to the preferred embodiment of the disclosure, the laminated body of the first ink layer and the second ink layer is covered with the transparent film. Light incident on the laminated body of the ink layers through the transparent film can thus be refracted through the transparent film. As a result, when the ink layer (front surface side ink layer) of the laminated body, that is close to the transparent film among the ink layers, is observed obliquely and/or laterally through the transparent film, an end portion color of the ink layer that is hidden by the front surface side ink layer can be made less likely to be observed.

### BRIEF DESCRIPTION OF DRAWINGS

FIG. 1 is a view schematically illustrating a structure of a printing device according to a preferred embodiment of the present disclosure.

FIG. 2 is a block diagram illustrating an electrical configuration of the printing device.

FIG. 3 is a schematic view illustrating a heating step and a cooling step of the printing device.

FIGS. 4A and 4B are schematic views illustrating a cooling step and a transferring step of the printing device.

FIG. 5A is a schematic cross-sectional view illustrating a layer configuration of a transfer-completed tape according to a preferred embodiment of the present disclosure.

FIG. 5B is a schematic cross-sectional view illustrating a layer configuration of a transfer-completed tape according to a preferred embodiment of the present disclosure.

FIG. 5C is a schematic cross-sectional view illustrating a layer configuration of a transfer-completed tape according to a preferred embodiment of the present disclosure.

FIGS. 6A and 6B are views illustrating an example of a printing pattern of the printing device.

FIG. 7 is a view for illustrating refraction of light in the transfer-completed tape of FIG. 5A.

FIG. 8 is a view for illustrating refraction of light in the transfer-completed tape of FIG. 5B.

FIG. 9 is a view for illustrating a method of evaluating an oblique observation.

### DESCRIPTION OF EMBODIMENTS

Next, preferred embodiments of the present disclosure will be described in detail with reference to the accompanying drawings. In the following detailed description, a plurality of components each of which has a name to which an ordinal number has been assigned exist, and yet this ordinal number and an ordinal number of a component recited in the claims do not necessarily coincide with each other.

### [Overall Configuration of Printing Apparatus 1]

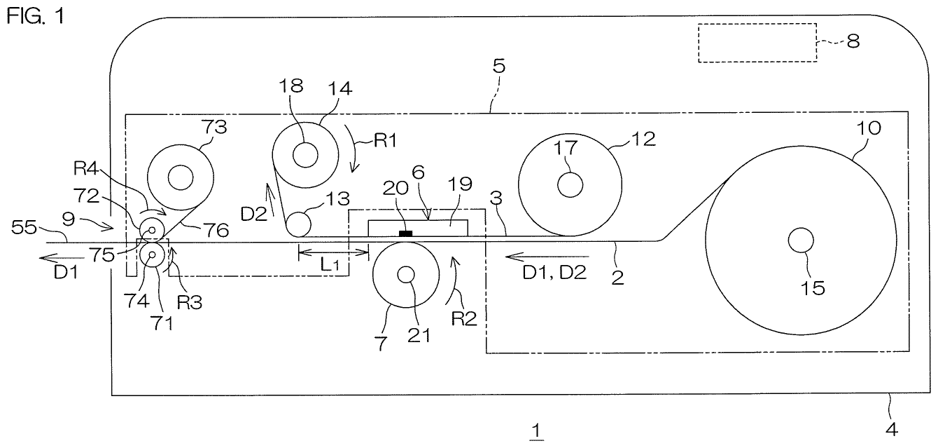

FIG. 1 is a view schematically illustrating a structure of a printing device 1 according to a preferred embodiment of the present disclosure.

With reference to FIG. 1, the printing device 1 is a thermal transfer printer that thermally transfers ink of an ink ribbon 3 as an example of a thermal transfer recording medium as characters to a printer tape 2 as an example of a printing target medium. In this preferred embodiment, the printer tape 2 is, for example, a transparent base material film to which ink is directly transferred. Here, the “transparency” of the printer tape 2 may be defined as that the printer tape 2 has such transparency that the shape and color of a character transferred to the printer tape 2 can be recognized from the side opposite to the transfer surface (printing surface).

Examples of characters to be recorded on the printer tape 2 may include a typical character, a symbol such as a barcode or a QR Code (registered trademark), a number, a figure, a pattern, and the like. The printing device 1 according to this preferred embodiment can record characters having different colors (for example, two colors including black and red) on the printer tape 2.

The printing device 1 mainly includes a housing 4, and a tape cassette 5, a thermal head 6, a platen roller 7, a nip roller 71, and a control board 8 which are housed within the housing 4.

The housing 4 may be a box-shaped member formed by, for example, a plastic case. An outlet 9 for taking out the printer tape 2 after printing is formed on an outer wall of the housing 4. A cutter (not illustrated) may be provided in the vicinity of the outlet 9. Cutting is performed using the cutter, and thereby the printer tape 2 can be separated into labels having a size for each usage unit and taken out.

The tape cassette 5 may be a removable cartridge with respect to the housing 4. The tape cassette 5 may accommodate a printer tape roll 10 (in other words, may be referred to as a label tape roll), an ink ribbon roll 12, an ink ribbon peeling member 13, an ink ribbon winding roll 14, a sticking roller 72, and a stick film roll 73 in this order from an upstream side to a downstream side in a tape transport direction D1 (a direction from right to left in FIG. 1). In this preferred embodiment, the printer tape roll 10, the ink ribbon roll 12, the sticking roller 72, and the stick film roll 73 are types used in a state of being accommodated in the tape cassette 5, but may be, for example, types used by being directly attached to the printing device 1.

The printer tape roll 10 is manufactured by winding the printer tape 2 in a cylindrical shape, and is rotatably held by the tape cassette 5, for example.

The ink ribbon roll 12 is manufactured by winding the ink ribbon 3 in a cylindrical shape, and is rotatably held by, for example, the tape cassette 5. A ribbon drive shaft 18 provided in the housing 4 is inserted into the ink ribbon winding roll 14. A rotative force R1 generated by driving the ribbon drive shaft 18 is transmitted to the ink ribbon winding roll 14, and the ink ribbon winding roll 14 is rotated.

The ink ribbon peeling member 13 may be a guide member that changes a transport direction D2 of the ink ribbon 3. The ink ribbon peeling member 13 may have a shape which can abut the ink ribbon 3 being transported, for example, a roller shape, or a blade shape. A part of the ink ribbon 3 is thermocompression-bonded to the printer tape 2 by the thermal head 6, and is transported together with the printer tape 2 toward the outlet 9. The ink ribbon peeling member 13 abuts the ink ribbon 3 in the middle of transport and changes the transport direction D2 of the ink ribbon 3 to a steep angle with respect to the transport direction D1 of the printer tape 2. Consequently, the printer tape 2 and the ink ribbon 3 are separated from each other, and the ink ribbon 3 is peeled from the printer tape 2.

A sticking roller drive shaft 75 provided in the housing 4, for example, can be inserted into the sticking roller 72. A rotative force R4 generated by driving the sticking roller drive shaft 75 is transmitted to the sticking roller 72, and the sticking roller 72 is rotated. As illustrated in FIG. 1, the sticking roller 72 is provided within the tape cassette 5 and partially exposed on the transport path of the printer tape 2. This makes it possible to transport the printer tape 2 by sandwiching between the sticking roller 72 and the nip roller 71 in a state where the tape cassette 5 is installed.

The stick film roll 73 is manufactured by winding a sticking tape 76 in a cylindrical shape, and is rotatably held by the tape cassette 5, for example.

The thermal head 6 is located between the ink ribbon peeling member 13 and both the printer tape roll 10 and the ink ribbon roll 12 in the transport direction D1 of the printer tape 2. The thermal head 6 includes a substrate 19 and a heating element 20 (for example, a heating resistor or the like) formed on the substrate 19. Joule heat generated by energization to the heating element 20 is used for thermal transfer of ink of the ink ribbon 3.

For example, a platen drive shaft 21 provided in the housing 4 is inserted into the platen roller 7. A rotative force R2 generated by driving the platen drive shaft 21 is transmitted to the platen roller 7, and the platen roller 7 is rotated.

For example, a nip roller drive shaft 74 provided in the housing 4 is inserted into the nip roller 71. A rotative force R3 generated by driving the nip roller drive shaft 74 is transmitted to the nip roller 71, and the nip roller 71 is rotated.

The control board 8 is an electronic instrument that executes electrical control of the printing device 1, and is installed inside the housing 4.

### [Electrical Configuration of Printing Device 1]

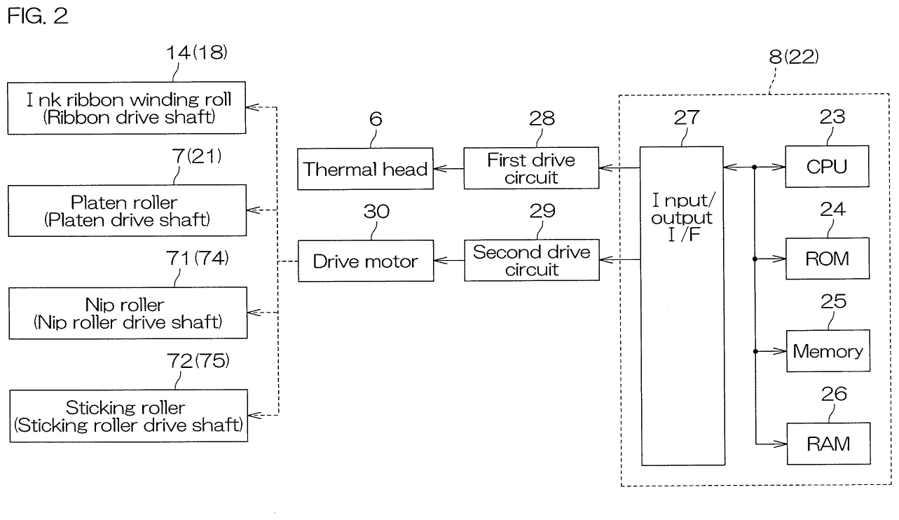

FIG. 2 is a block diagram illustrating an electrical configuration of the printing device 1.

With reference to FIG. 2, a control circuit 22 is provided on the control board 8 of the printing device 1. The control circuit 22 may include a CPU 23, a ROM 24, a memory 25, a RAM 26, and an input/output I/F 27 (interface). These elements are electrically connected through, for example, a data bus (not illustrated).

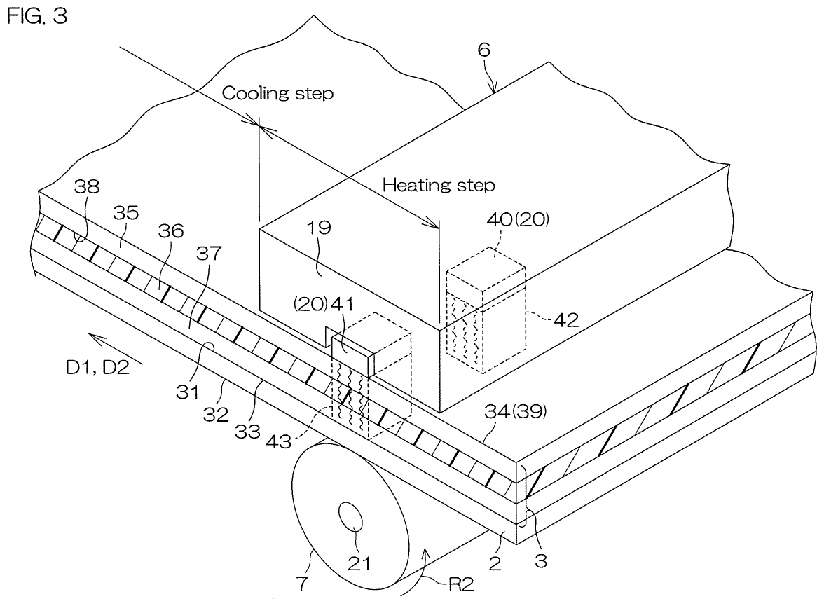

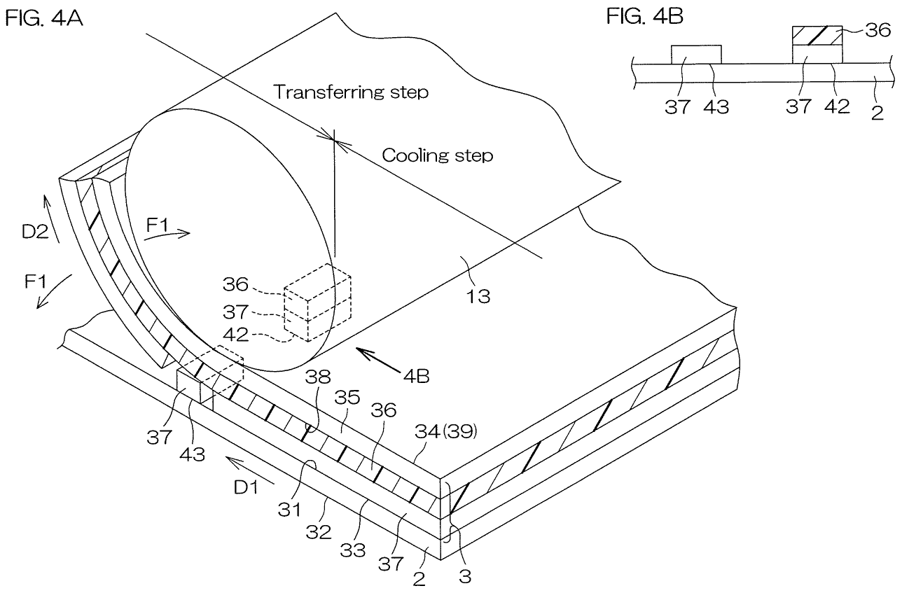

The ROM 24 stores various programs (for example, a control program or the like for executing steps illustrated in FIGS. 3 and 4A and 4B) for driving the printing device 1. The CPU 23 executes signal processing according to a program stored in the ROM 24 while using the temporary storage function of the RAM 26 and controls the printing device 1 as a whole. The memory 25 may be configured of, for example, a part of a storage region of the ROM 24. In the memory 25, a table for displaying a remaining amount (consumption amount) of the ink ribbon 3 on a display portion (not illustrated) of the housing 4 may be stored in advance.

A first drive circuit 28 and a second drive circuit 29 are electrically connected to the input/output I/F 27. The first drive circuit 28 executes energization control of the heating element 20 of the thermal head 6. The second drive circuit 29 executes drive control of outputting a drive pulse to a drive motor 30 that rotationally drives the ink ribbon winding roll 14, the platen roller 7, the nip roller 71, and the sticking roller 72.

### [Flow of Printing Step by Printing Device 1]

FIG. 3 is a schematic view illustrating a heating step and a cooling step of the printing device 1. FIGS. 4A and 4B are schematic views illustrating a cooling step and a transferring step of the printing device 1. FIG. 4B is an enlarged view of a main part when a transfer pattern is viewed from a direction of an arrow 4B in FIG. 4A. A printing step executed by the printing device 1 will be specifically described with reference to FIGS. 1, 3, 4A, and 4B.

In order to print characters on the printer tape 2, the printer tape 2 is pulled out from the printer tape roll 10 by rotationally driving the platen roller 7, and the ink ribbon 3 is pulled out from the ink ribbon roll 12 by rotationally driving the ink ribbon winding roll 14. Consequently, as illustrated in FIGS. 1 and 3, the printer tape 2 and the ink ribbon 3 are transported toward the downstream side in a state of overlapping each other. Regarding the printer tape 2, a surface on the ink ribbon 3 side is a printing surface 31 (front surface), and a surface on the opposite side thereof is a back surface 32. Regarding the ink ribbon 3, a surface on the printer tape 2 side is an adhesive surface 33 (front surface), and a surface on the opposite side thereof is a back surface 34.

With reference to FIG. 3, the ink ribbon 3 includes a base material layer 35, a first ink layer 36, and a second ink layer 37. The first ink layer 36 and the second ink layer 37 are laminated in this order on a front surface 38 as an example of a first surface of the base material layer 35. A surface on the opposite side to the front surface 38 of the base material layer 35 is a back surface 39 (the back surface 34 of the ink ribbon 3). The first ink layer 36 and the second ink layer 37 contain colorants having different colors. For example, the first ink layer 36 may contain a black colorant and the second ink layer 37 may contain a red colorant.

The ink ribbon 3 is transported toward the thermal head 6 in a state in which the second ink layer 37 and the printer tape 2 are in contact with each other. In the thermal head 6, the heating step is executed as illustrated in FIG. 3. Specifically, the heating element 20 that generates heat due to energization is pressed against the ink ribbon 3, and thereby the heat is transmitted to the first ink layer 36 and the second ink layer 37 through the base material layer 35. A laminated body of the ink ribbon 3 and the printer tape 2 is sandwiched between the thermal head 6 and the platen roller 7, and thereby the laminated body is transported to the downstream side while being heated by the thermal head 6.

The heating element 20 may be controlled at the same temperature as a whole, or may be controlled at partially different temperatures. For example, as illustrated in FIG. 3, a first portion 40 of the heating element 20 may be controlled at a relatively low first heating temperature, and a second portion 41 of the heating element 20 may be controlled at a second heating temperature higher than the first heating temperature. The first heating temperature may be controlled by applying a relatively low first energy amount to the thermal head 6, and the second heating temperature may be controlled by applying a second energy amount that is relatively higher than the first energy amount to the thermal head 6.

The first heating temperature may be, for example, 60° C. or higher and 120° C. or lower, and preferably 70° C. or higher and 90° C. or lower. The second heating temperature may be, for example, 80° C. or higher and 180° C. or lower, and preferably 130° C. or higher and 150° C. or lower. The first energy amount and the second energy amount may be set in accordance with specifications of the printing device 1 such that the thermal head 6 is heated to the first heating temperature and the second heating temperature, respectively. For example, a voltage value may be set in the printing device 1 with specifications in which the energy amount to be applied can be set directly with a voltage value, or an energy amount at an appropriate stage may be set in the printing device 1 with specifications in which the energy amount to be applied is increased or decreased by adjusting the energy amount divided into multiple stages.

Consequently, the ink ribbon 3 may include a first portion 42 heated at the first heating temperature and a second portion 43 heated at the second heating temperature. In the first portion 42 and the second portion 43 of the ink ribbon 3, at least a part or all of the first ink layer 36 and the second ink layer 37 is melted or softened, and comes into close contact with the printer tape 2.

With reference to FIGS. 3, 4A, and 4B, the cooling step is executed in a zone between the thermal head 6 and the ink ribbon peeling member 13. Specifically, the ink ribbon 3 thermocompression-bonded to the printer tape 2 in the heating step is naturally cooled in a zone from the thermal head 6 to the ink ribbon peeling member 13, and the temperature decreases toward a use environmental temperature of the printing device 1.

Thereafter, as illustrated in FIGS. 4A and 4B, an external force F1 is applied to the base material layer 35 and the second ink layer 37 in a direction in which the layers are separated from each other, by causing the ink ribbon peeling member 13 to selectively change only the transport direction D2 of the ink ribbon 3. Consequently, the printer tape 2 and the ink ribbon 3 are separated from each other, and the ink ribbon 3 is wound around the ink ribbon winding roll 14. At this time, in the ink ribbon 3, the first portion 42 and the second portion 43 heated by the thermal head 6 selectively remain on the printer tape 2, and thereby the transferring step is executed. For example, in the first portion 42, peeling may occur between the base material layer 35 and a laminated body including the first ink layer 36 and the second ink layer 37, and the laminated body may be transferred. On the other hand, in the second portion 43, peeling may occur between the first ink layer 36 and the second ink layer 37, and the second ink layer 37 may be selectively transferred.

As illustrated in FIG. 1, a sticking tape 76 is then stuck to the printer tape 2 to which the first ink layer 36 and the second ink layer 37 have been transferred. A transfer-completed tape 55 formed by sticking the sticking tape 76 to the printer tape 2 and having characters recorded thereon is discharged through the outlet 9 of the printing device 1.

### [Layer Configuration of Transfer-Completed Tape 55]

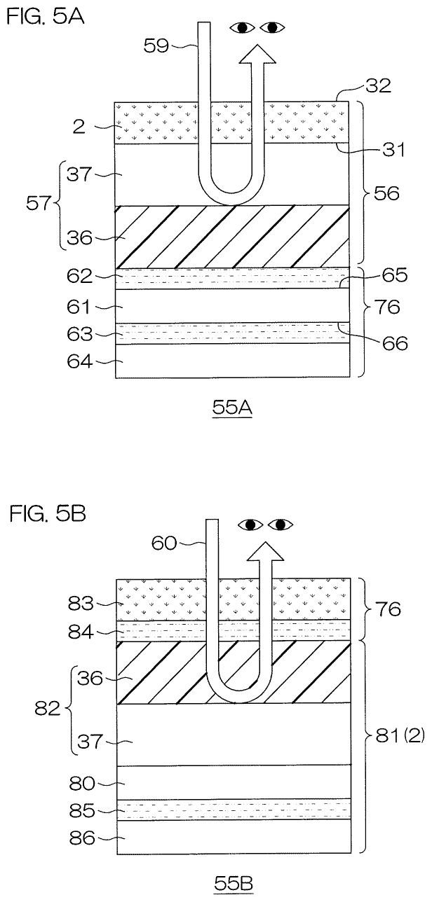

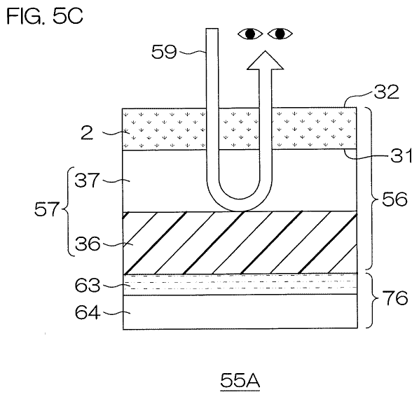

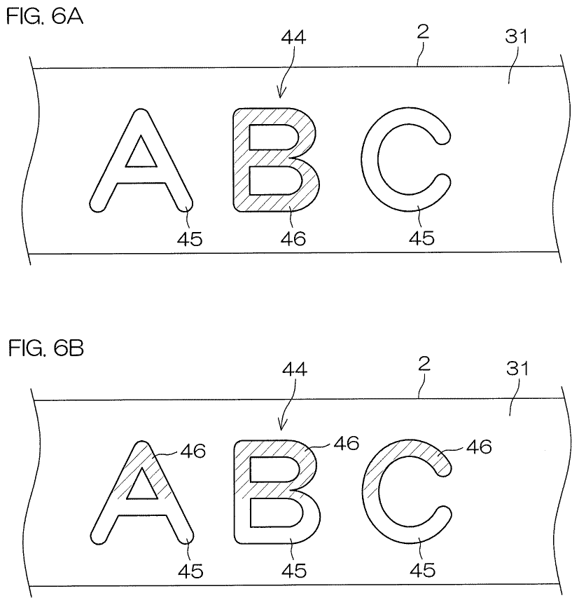

FIGS. 5A and 5B are schematic cross-sectional views illustrating a layer configuration of the transfer-completed tape 55 according to a preferred embodiment of the present disclosure. FIGS. 6A and 6B are views illustrating an example of a printing pattern 44 of the printing device 1.

With reference to FIGS. 5A and 5B, the transfer-completed tape 55 is roughly divided into two layer configurations depending on the type of the printer tape 2. FIG. 5A illustrates a transfer-completed tape 55A that includes the printer tape 2 as a transparent base material film (base material tape), which is an example of the transparent film, and FIG. 5B illustrates a transfer-completed tape 55B that includes the printer tape 2 as a non-transparent base material film (base material tape). Layer configurations of the transfer-completed tape 55A and the transfer-completed tape 55B will each be described below.

### <Transfer-Completed Tape 55A>

With reference to FIG. 5A, the transfer-completed tape 55A includes a print product 56 that includes the printer tape 2 to which a portion of the ink ribbon 3 is transferred, and the sticking tape 76 that is stuck to the print product 56. The sticking tape 76 may be referred to as a stick film. FIG. 5A illustrates a cross-section of a portion of the transfer-completed tape 55A to which the laminated body of the first ink layer 36 and the second ink layer 37 has been transferred as a first transfer layer 57, and a cross-section of a portion of the transfer-completed tape 55A to which the second ink layer 37 has been transferred selectively as a second transfer layer 58 is omitted.

In the transfer-completed tape 55A of this preferred embodiment, the sticking tape 76 is formed as a support film that supports the first transfer layer 57. The printer tape 2 is formed as a transparent cover film that physically protects the first transfer layer 57 against the exterior. Accordingly, in the first transfer layer 57, the second ink layer 37 on a side closer to the printer tape 2 is a front surface side ink layer (observation surface side ink layer). As indicated by an open arrow 59, a person can recognize the color of the first ink layer 36 and the second ink layer 37 via light transmitted through the printer tape 2 and reflected at the first ink layer 36 or the second ink layer 37.

Printing patterns 44 of different colors (e.g. two colors recognized as black and red) are formed on the transfer-completed tape 55. For example, as illustrated in FIG. 6A, the printing pattern 44 may have a different color for each independent character. In FIG. 6A, when the printing pattern 44 is viewed from the back surface 32 side of the printer tape 2, a red pattern 45 based on the second ink layer 37 may be recognized on the outermost surfaces of alphabets “A” and “C,” and a black pattern 46 based on the first ink layer 36 may be recognized on the outermost surface of “B.” On the other hand, as illustrated in FIG. 6B, in the printing pattern 44, both the red pattern 45 and the black pattern 46 may be recognized for each portion of the characters.

Next, a layer configuration of the transfer-completed tape 55A will be described more specifically.

As mentioned above, the transfer-completed tape 55A is formed by sticking the print product 56 and the sticking tape 76 to each other.

The print product 56 includes the printer tape 2, and the first transfer layer 57 that is formed selectively on the printing surface 31 of the printer tape 2. The first transfer layer 57 includes the second ink layer 37 and the first ink layer 36 that are sequentially laminated on the printing surface 31.

### (1) Printer Tape 2

The printer tape 2 is not particularly limited as long as it is a transparent base material film to which ink is directly transferred, and examples thereof include resin films such as polyester, polyethylene, polypropylene, polyamide, polyimide, polycarbonate, polystyrene, and fluororesin. Among them, a film of polyethylene terephthalate (PET), which is polyester, is preferable from the viewpoint of mechanical strength, dimensional stability, heat treatment resistance, price, or the like. The printer tape 2 may be a single layer of any of the resin films described above, or may be a laminated film formed by layering more than one of the resin films described above.

Although the printer tape 2 may be formed from the various resin films described above, the printer tape 2 may be selected on the basis of the refractive index of each resin film. For example, the printer tape 2 has a refractive index of 1.4 or more, preferably 1.5 or more, and more preferably 1.6 or more. The refractive index may be measured by, for example, spectroscopic ellipsometry.

The thickness of the printer tape 2 can be set arbitrarily according to, for example, specifications of the thermal transfer printer, the characteristics required for the printer tape 2, and the like. For example, the printer tape 2 has a thickness of 1 μm or more, preferably 2 μm or more, and more preferably 5 μm or more. For example, the printer tape 2 has a thickness of 30 μm or less, preferably 15 μm or less, and more preferably 10 μm or less. For example, the printer tape 2 has a thickness of 1 μm or more and 30 μm or less, preferably 2 μm or more and 15 μm or less, and more preferably 5 μm or more and 10 μm or less.

The printer tape 2, as long as having a thickness within this range, can exhibit sufficient mechanical strength and/or elasticity while imparting appropriate flexibility to the transfer-completed tape 55A. The printer tape 2 may be thinner than the above range when placing significance on the flexibility of the transfer-completed tape 55A. It is thereby possible to favorably stick the transfer-completed tape 55A even to a complicated curved surface. On the other hand, the printer tape 2 may be thicker than the above range when placing significance on the mechanical strength and/or elasticity of the transfer-completed tape 55A. It is thereby possible to prevent generation of wrinkles in the printer tape 2 during transport in the printing device 1 and/or during sticking of the sticking tape 76. The thickness of the printer tape 2 is preferably greater than the thickness of the second ink layer 37 to be described below.

The printer tape 2 may be an unstretched film that has not been subjected to stretching processing in the course of its production, or may be a stretched film that has been subjected to stretching processing such as uniaxial stretching and biaxial stretching. Also, the surfaces (the printing surface 31 and the back surface 32) of the printer tape 2 may be subjected to surface finish processing such as glossy finish or matte finish. Furthermore, a primer layer for improving printability onto the printer tape 2, an overcoat layer for adjusting frictional force, a peel-off layer that uses silicone for protecting the surfaces of the printer tape 2 before use, and the like may be formed separately. These layers may conceptually be part of the printer tape 2.

As a numerical value that represents the transparency of the printer tape 2, a total light transmittance, for example, may be used that is measured in conformity with JIS K 7361. The printer tape 2 may have a total light transmittance of, for example, 80% or more, and preferably 85% or more. The total light transmittance of the printer tape 2 can be measured using, for example, a haze meter.

### (2) First Ink Layer 36

The first ink layer 36 can be made of, for example, any thermoplastic resin. The first ink layer 36 is preferably formed using an epoxy resin as the thermoplastic resin. The first ink layer 36 can be formed using, as a thermoplastic resin, an epoxy resin in a (excluding) state in which a curing agent is not blended.

Examples of the epoxy resin include a bisphenol A epoxy resin, a bisphenol F epoxy resin, a phenol novolac epoxy resin, a cresol novolac epoxy resin, an alicyclic epoxy resin, a hydrogenated bisphenol A epoxy resin, a hydrogenated bisphenol AD epoxy resin, an aliphatic epoxy resin such as propylene glycol glycoxyl ether or pentaerythritol polyglycidyl ether, an epoxy resin obtained from aliphatic or aromatic amine and epichlorohydrin, an epoxy resin obtained from aliphatic or aromatic carboxylic acid and epichlorohydrin, a heterocyclic epoxy resin, a spirocyclic epoxy resin, an epoxy-modified resin, a brominated epoxy resin, and the like. Specific examples of the epoxy resin are not particularly limited, but include, for example, the following various types of epoxy resin. These epoxy resins can be used individually or in combination of two or more kinds thereof.

Among the JER (registered trademark) series of epoxy resins manufactured by Mitsubishi Chemical Corporation, basic solid types 1001 [softening point (ring and ball method): 64° C., number average molecular weight Mn: about 900], 1002 [softening point (ring and ball method): 78° C., number average molecular weight Mn: about 1200], 1003 [softening point (ring and ball method): 89° C., number average molecular weight Mn: about 1300], 1055 [softening point (ring and ball method): 93° C., number average molecular weight Mn: about 1600], 1004 [softening point (ring and ball method): 97° C., number average molecular weight Mn: about 1650], 1004AF [softening point (ring and ball method): 97° C., number average molecular weight Mn: about 1650], 1007 [softening point (ring and ball method): 128° C., number average molecular weight Mn: about 2900], 1009 [softening point (ring and ball method): 144° C., number average molecular weight Mn: about 3800], 1010 [number average molecular weight Mn: about 5500], 1003F [softening point (ring and ball method): 96° C.], 1004F [softening point (ring and ball method): 103° C.], 1005F, 1009F [softening point (ring and ball method): 144° C.], 1004FS [softening point (ring and ball method): 100° C.], 1006FS [softening point (ring and ball method): 112° C.], and 1007FS [softening point (ring and ball method): 124° C.].

The softening point of the epoxy resin used in the first ink layer 36 is, for example, 95° C. or higher, preferably 110° C. or higher, and more preferably 125° C. or higher. When the softening point falls within this range, it is possible to prevent a high adhesive force from being generated between the first ink layer 36 and the base material layer 35 (see FIGS. 3, 4A, and 4B) at a relatively low temperature during low-temperature transfer. Since the low-temperature transfer range of the first ink layer 36 can be sufficiently widened toward a high temperature side, it is possible to prevent the color tones from becoming dusky even in the continuous thermal transfer recording.

The first ink layer 36 may contain an adhesive in addition to the epoxy resin. Examples of the adhesive include a rubber-based adhesive, an acrylic adhesive, a silicone-based adhesive, a vinyl alkyl ether-based adhesive, a polyvinyl alcohol-based adhesive, a polyvinylpyrrolidone-based adhesive, a polyacrylamide-based adhesives, a cellulose-based adhesive, and the like.

In consideration of improving affinity and compatibility with the epoxy resin, the acrylic adhesive is preferable as the adhesive. Specific examples of the acrylic adhesive are not particularly limited, and include the following various acrylic adhesives. These acrylic adhesives can be used individually or in combination of two or more kinds thereof.

Among the ORIBAIN (registered trademark) BPS (solvent-based) series manufactured by Toyochem Co., Ltd., BPS1109 (nonvolatile content: 39.5 mass %), BPS3156D (nonvolatile content: 34 mass %), BPS4429-4 (nonvolatile content: 45 mass %), BPS4849-40 (nonvolatile content: 40 mass %), BPS5160 (nonvolatile content: 33 mass %), BPS5213K (nonvolatile content: 35 mass %), BPS5215K (nonvolatile content: 39 mass %), BPS5227-1 (nonvolatile content: 41.5 mass %), BPS5296 (nonvolatile content: 37 mass %), BPS5330 (nonvolatile content: 40 mass %), BPS5375 (nonvolatile content: 45 mass %), BPS5448 (nonvolatile content: 40 mass %), BPS5513 (nonvolatile content: 44.5 mass %), BPS5565K (nonvolatile content: 45 mass %), BPS5669K (nonvolatile content: 46 mass %), BPS5762K (nonvolatile content: 45.5 mass %), BPS5896 (nonvolatile content: 37 mass %), BPS5978 (nonvolatile content: 35 mass %), BPS6074HTF (nonvolatile content: 52 mass %), BPS6080TFK (nonvolatile content: 45 mass %), BPS6130TF (nonvolatile content: 45.5 mass %), BPS6153K (nonvolatile content: 25 mass %), BPS6163 (nonvolatile content: 37 mass %), BPS6231 (nonvolatile content: 56 mass %), BPS6421 (nonvolatile content: 47 mass %), BPS6430 (nonvolatile content: 33 mass %), BPS6574 (nonvolatile content: 57 mass %), BPS8170 (nonvolatile content: 36.5 mass %), and BPS HS-1 (nonvolatile content: 40 mass %).

Among solvent type adhesives (removable type) manufactured by Lion Specialty Chemicals Co., Ltd., AS-325 (solid concentration: 45 mass %), AS-375 (solid concentration: 45 mass %), AS-409 (solid concentration: 45 mass %), AS-417 (solid concentration: 45 mass %), AS-425 (solid concentration: 45 mass %), AS-455 (solid concentration: 45 mass %), AS-665 (solid concentration: 40 mass %), AS-1107 (solid concentration: 43 mass %), and AS-4005 (solid concentration: 45 mass %).

The acrylic adhesive used in the first ink layer 36 may be used in combination with a tackifier. This is because, for example, it is possible to increase the sharpness of the first ink layer 36, prevent the extra peeling, and improve the sharpness of the character to be recorded. Examples of the tackifier include ester gum, terpene phenolic resin, rosin ester, and the like. Specific examples of the tackifier are not particularly limited, and include the following various tackifiers. These tackifiers can be used individually or in combination of two or more kinds thereof.

Among the YS POLYSTER series of terpene phenol resins manufactured by Yasuhara Chemical Co., Ltd., U130 (softening point: 130±5° C.), U115 (softening point: 115+±5° C.), T160 (softening point: 160±5° C.), T145 (softening point: 145±5° C.), T130 (softening point: 130±5° C.), T115 (softening point: 115±5° C.), T100 (softening point: 100±5° C.), T80 (softening point: 80±5° C.), S145 (softening point: 145±5° C.), G150 (softening point: 150±5° C.), G125 (softening point: 125±5° C.), N125 (softening point: 125±5° C.), K125 (softening point: 125±5° C.), and TH130 (softening point: 130±5° C.).

Among the ester gums manufactured by Arakawa Chemical Industries, Ltd., AA-G [softening point (ring and ball method): 82 to 88° C.], AA-L [softening point (ring and ball method): 82 to 88° C.], AA-V [softening point (ring and ball method): 82 to 95° C.], 105 [softening point (ring and ball method): 100 to 110° C.], AT [viscosity: 20,000 to 40,000 mPa·s], H [softening point (ring and ball method): 68 to 75° C.], and HP [softening point (ring and ball method): 80° C. or higher].

Among the PENSEL (registered trademark) series of rosin esters manufactured by Arakawa Chemical Industries, Ltd., GA-100 [softening point (ring and ball method): 100 to 110° C.], AZ [softening point (ring and ball method): 950 to 105° C.], C [softening point (ring and ball method): 117 to 127° C.], D-125 [softening point (ring and ball method): 120 to 130° C.], D-135 [softening point (ring and ball method): 130 to 140° C.], D-160 [softening point (ring and ball method): 150 to 165° C.], and KK [softening point (ring and ball method): 165° C. or higher].

The softening point of the tackifier used in the first ink layer 36 is, for example, 60° C. or higher, and preferably 120° C. or lower. When the softening point falls within this range, the first ink layer 36 can be reversely transferred favorably to a base material layer 48 side at the time of high-temperature transfer. Since the high-temperature transfer range of the first ink layer 36 can be sufficiently widened to a low temperature side, it is possible to prevent the color tones from becoming dusky.

The first ink layer 36 may contain any colorant. As the colorant, one or more kinds of various colorants corresponding to the color tone of the first ink layer 36 can be used. For example, pigments or dyes may be used as the colorants. In consideration of the concealing property of the base, etc., the pigments are preferable as the colorants used in the first ink layer 36. In the transfer-completed tape 55A, the black color of the first ink layer 36 is recognized via light transmitted through the transparent printer tape 2 and the second ink layer 37 and reflected at the first ink layer 36. That is, the black color of the first ink layer 36 can be favorably recognized through the printer tape 2 and the second ink layer 37 by reducing transmission of light through the first ink layer 36. For example, carbon black is preferable as a pigment for coloring the first ink layer 36 black. Specific examples of the carbon black are not particularly limited, and include the following various carbon blacks. These carbon blacks can be used individually or in combination of two or more kinds thereof.

MA77 in powder form [LFF, DBP absorption amount: 68 cm³/100 g], MA7 in powder form [LFF, DBP absorption amount: 66 cm³/100 g], MA7 in particle form [LFF, DBP absorption amount: 65 cm³/100 g], MA8 in powder form [LFF, DBP absorption amount: 57 cm³/100 g], MA8 in particle form [LFF, DBP absorption amount: 51 cm³/100 g], MA11 in powder form [LFF, DBP absorption amount: 64 cm³/100 g], MA100 in powder form [LFF, DBP absorption amount: 100 cm³/100 g], MA100 in particle form [LFF, DBP absorption amount: 95 cm³/100 g], MA100R in powder form [LFF, DBP absorption amount: 100 cm³/100 g], MA100R in particle form [LFF, DBP absorption amount: 95 cm³/100 g], MA100S in powder form [LFF, DBP absorption amount: 100 cm³/100 g], MA230 in powder form [LFF, DBP absorption amount: 113 cm³/100 g], MA220 in powder form [LFF, DBP absorption amount: 93 cm³/100 g], and MA14 in powder form [LFF, DBP absorption amount: 73 cm³/100 g] manufactured by Mitsubishi Chemical Corporation.

#3030B (furnace method, DBP absorption amount: 130 cm³/100 g), #3040B (furnace method, DBP absorption amount: 114 cm³/100 g), #3050B (furnace method, DBP absorption amount: 175 cm³/100 g), #3230B (furnace method, DBP absorption amount: 140 cm³/100 g), #3350B (furnace method, DBP absorption amount: 164 cm³/100 g), and #3400B (furnace method, DBP absorption amount: 175 cm³/100 g) manufactured by Mitsubishi Chemical Corporation.

Among the TOKABLACK (registered trademark) series manufactured by Tokai Carbon Co., Ltd., #5500 (furnace method, DBP absorption amount: 155 cm³/100 g), #4500 (furnace method, DBP absorption amount: 168 cm³/100 g), #4400 (furnace method, DBP absorption amount: 135 cm³/100 g), and #4300 (furnace method, DBP absorption amount: 142 cm³/100 g).

Among the PRINTEX (registered trademark) series manufactured by ORION ENGINEERED CARBONS S.A., L (furnace method, DBP absorption amount: 120 cm³/100 g) and L6 (furnace method, DBP absorption amount: 126 cm³/100 g).

Among the CONDUCTEX (registered trademark) series manufactured by Birla Carbon Inc., 975 (furnace method, 170 cm³/100 g) and SC (furnace method, 115 cm³/100 g).

Among the VULCAN (registered trademark) series manufactured by Cabot Corporation, XC72 (furnace method, DBP absorption amount: 174 cm³/100 g) and among the BLACK PEARLS series manufactured by Cabot Corporation, 9A32 (furnace method, DBP absorption amount: 114 cm³/100 g) and 3700 (furnace method, DBP absorption amount: 111 cm³/100 g).

Among the DENKA BLACK (registered trademark) series manufactured by Denka Company Limited, DENKA BLACK granular product (acetylene method, DBP absorption amount: 160 cm³/100 g), FX-35 (acetylene method, DBP absorption amount: 220 cm³/100 g), and HS-100 (acetylene method, DBP absorption amount: 140 cm³/100 g).

Among the KETJENBLACK (registered trademark) series manufactured by Lion Specialty Chemicals Co., Ltd., EC300J (gasification method, DBP absorption amount: 360 cm³/100 g) and EC600DJ (gasification method, DBP absorption amount: 495 cm³/100 g).

Ratios of components in the first ink layer 36 are not particularly limited. The ratio of the acrylic adhesive with respect to 100 parts by mass of the epoxy resin is, for example, 30 parts by mass or more, and preferably 40 parts by mass or more. The ratio of the acrylic adhesive with respect to 100 parts by mass of the epoxy resin is, for example, 150 parts by mass or less, and preferably 100 parts by mass or less. The ratio of the acrylic adhesive with respect to 100 parts by mass of the epoxy resin is, for example, 30 parts by mass or more and 150 parts by mass or less, and preferably 40 parts by mass or more and 100 parts by mass or less.

The ratio of the tackifier with respect to 100 parts by mass of the epoxy resin is, for example, 3 parts by mass or more, and preferably 5 parts by mass or more. The ratio of the tackifier with respect to 100 parts by mass of the epoxy resin is, for example, 150 parts by mass or less, and preferably 100 parts by mass or less. The ratio of the tackifier with respect to 100 parts by mass of the epoxy resin is, for example, 3 parts by mass or more and 150 parts by mass or less, and preferably 5 parts by mass or more and 100 parts by mass or less.

A ratio of the colorant such as carbon black with respect to 100 parts by mass of the epoxy resin is, for example, 100 parts by mass or more, and preferably 130 parts by mass or more. The ratio of the colorant with respect to 100 parts by mass of the epoxy resin is, for example, 230 parts by mass or less, and preferably 200 parts by mass or less. The ratio of the colorant with respect to 100 parts by mass of the epoxy resin is, for example, 100 parts by mass or more and 230 parts by mass or less, and preferably 130 parts by mass or more and 200 parts by mass or less.

Note that, of the components contained in the first ink layer 36, a blending amount of a component which is supplied in a liquid form dissolved or dispersed in any solvent may be adjusted so that a ratio of an active component falls within the above range (the same being applied to the following).

The first ink layer 36 can be formed, for example, by applying, onto the front surface 38 of the base material layer 35 directly or through any release layer, a coating material obtained by dissolving or dispersing each of the above-described components in any solvent, and then drying the coating material. In the present disclosure, as illustrated in FIGS. 6A and 6B, the characters to be recorded on the printer tape 2 are color-coded. In order to perform this color-coding, it is preferable that the first ink layer 36 is directly formed on the front surface 38 of the base material layer 35 without the release layer, in consideration of adjustment of the adhesion between the first ink layer 36 and the base material layer 35 or each of other layers.

A thickness of the first ink layer 36 can be arbitrarily set according to, for example, specifications of a thermal transfer printer. The thickness of the first ink layer 36 can be adjusted by an application amount of the first ink layer 36.

For example, the application amount of the first ink layer 36 is 0.1 g/m² or more, and preferably 0.5 g/m² or more in terms of solid content per unit area. For example, the application amount of the first ink layer 36 is 3.0 g/m² or less, and preferably 2.5 g/m² or less in terms of solid content per unit area. For example, the application amount of the first ink layer 36 is 0.1 g/m² or more and 3.0 g/m² or less, and preferably 0.5 g/m² or more and 2.5 g/m² or less in terms of solid content per unit area.

The first ink layer 36 has a specific thickness (before printing) of, for example, 0.05 μm or more, and preferably 0.5 μm or more. The first ink layer 36 has a thickness of, for example, 3.0 μm or less, and preferably 2.5 μm or less. The first ink layer 36 has a thickness of, for example, 0.05 μm or more and 3.0 μm or less, and preferably 0.5 μm or more and 2.5 μm or less. The thickness of the first ink layer 36 can be checked based on, for example, a scanning electron microscope (SEM) image, a transmission electron microscope (TEM) image, or the like of the ink ribbon 3.

### (3) Second Ink Layer 37

The second ink layer 37 can be made of, for example, any thermoplastic resin. Examples of the thermoplastic resin used for the second ink layer 37 include an epoxy resin, a polyester resin, a polyolefin resin, and the like. The thermoplastic resin can be appropriately selected according to a forming material or the like for the printer tape 2. In a case where the first ink layer 36 is made of the epoxy resin, it is preferable that the second ink layer 37 is also made of the epoxy resin similarly.

The adhesion of the first ink layer 36 to the base material layer 35 and the adhesion of the second ink layer 37 to the printer tape 2 can be balanced by making the second ink layer 37 of the epoxy resin. Consequently, at the time of high-temperature transfer, the first ink layer 36 can be favorably separated toward the base material layer 35 side, and the second ink layer 37 can be favorably separated toward the printer tape 2 side. Since the high-temperature transfer range can be widened to the low temperature side, the effect of preventing the color tone from becoming dusky can be further improved. Examples of the epoxy resin include various epoxy resins exemplified as the epoxy resin of the first ink layer 36. These epoxy resins can be used individually or in combination of two or more kinds thereof.

The second ink layer 37 may contain wax in addition to the thermoplastic resin. By containing the wax, it is made possible to favorably separate the first ink layer 36 toward the base material layer 35 side and favorably separate the second ink layer 37 toward the printer tape 2 side at the time of high-temperature transfer. Therefore, since the high-temperature transfer range can be widened to the low temperature side, the effect of preventing the color tone from becoming dusky can be further improved.

As the wax, any wax having affinity with or compatibility with a thermoplastic resin such as an epoxy resin can be used. For example, natural wax such as carnauba wax, paraffin wax, and microcrystalline wax, and synthetic wax such as Fischer Tropsch wax can be used. Specific examples of the wax are not particularly limited, and include carnauba wax No. 1 flake, No. 2 Flake, No. 3 Flake, No. 1 Powder and No. 2 Powder (melting points of all the products: 80 to 86° C.) manufactured by TOYOCHEM CO., LTD., EMUSTAR-1155 (melting point: 69° C.), EMUSTAR-0135 (melting point: 60° C.), EMUSTAR-0136 (melting point: 60° C.) and the like which are paraffin wax products manufactured by NIPPON SEIRO CO., LTD., EMUSTAR-0001 (melting point: 84° C.), EMUSTAR-042X (melting point: 84° C.) and the like which are microcrystalline wax products manufactured by NIPPON SEIRO CO., LTD., FNP-0090 (condensation point: 90° C.), SX80 (condensation point: 83° C.), FT-0165 (melting point: 73° C.), FT-0070 (melting point: 72° C.), and the like which are Fischer Tropsch wax products manufactured by NIPPON SEIRO CO., LTD. These wax products can be used individually or in combination of two or more kinds thereof.

The second ink layer 37 may contain any colorant. As the colorant, one or more kinds of various colorants corresponding to the color tone of the second ink layer 37 can be used. For example, pigments or dyes may be used as the colorants. In the transfer-completed tape 55A, the black color of the first ink layer 36 is recognized via light transmitted through the transparent printer tape 2 and the second ink layer 37 and reflected at the first ink layer 36. Accordingly, from the viewpoint of securing transparency to the first ink layer 36, the second ink layer 37 preferably contains colorant that at least contains dye. The second ink layer 37 preferably contains only dye as colorant, but may contain dye and pigment in a ratio smaller than that of the dye.

As an index of transparency to the first ink layer 36, a total light transmittance may be used that is measured in conformity with JIS K 7361. The second ink layer 37 may have a total light transmittance of, for example, 16% or more, and preferably 16.5% or more.

Examples of the dye for coloring the second ink layer 37 red include oil-soluble dye, acid dye, basic dye, and gold-containing dye, and various salt forming types of dye thereof, etc., and the following various types of red dye. These red dyes can be used individually or in combination of two or more kinds thereof.

C.I. Basic Red 1, 12, 13, C.I. Acid Red 13, 14, 18, 27, 50, 52, C.I. Solvent Red 25, 27, 30, 35, 49, 83, 89, 100, 122, 138, 149, 150, 160, 179, 218, 230, C.I. Direct Red 20, 37, 39, 44, C.I. Disperse Red 5, 7, 13, 17.

Examples of the pigments for coloring the second ink layer 37 red include the following various red pigments. These red pigments can be used individually or in combination of two or more kinds thereof.

C.I. Pigment Red 5, 7, 9, 12, 48 (Ca), 48 (Mn), 49, 52, 53, 53:1, 57 (Ca), 57:1, 97, 112, 122, 123, 149, 168, 177, 178, 179, 184, 202, 206, 207, 209, 242, 254, 255.

Also, the color difference of reflected light from the second ink layer 37 that has the exemplified composition has an L value of 20 or less, preferably 15 or less, more preferably 10 or less, and particularly preferably 5 or less. The L value may be, for example, a reflection density (L value) measured using a reflection color difference meter upon incidence of a light flux from the second ink layer 37 side of the ink ribbon 3. The transparency to the first ink layer 36 can be ensured sufficiently as long as the L value of reflected light from the second ink layer 37 is within the above range.

Ratios of components in the second ink layer 37 are not particularly limited. A ratio of the wax with respect to 100 parts by mass of the epoxy resin is, for example, 3 parts by mass or more, and preferably 5 parts by mass or more. The ratio of the wax with respect to 100 parts by mass of the epoxy resin is, for example, 11 parts by mass or less, and preferably 9 parts by mass or less. The ratio of the wax with respect to 100 parts by mass of the epoxy resin is, for example, 3 parts by mass or more and 11 parts by mass or less, and preferably 5 parts by mass or more and 9 parts by mass or less.

A ratio of the colorant such as a red dye (the total amount of the colorant) with respect to 100 parts by mass of the epoxy resin is, for example, 70 parts by mass or more, and preferably 80 parts by mass or more. The ratio of the colorant such as the red dye with respect to 100 parts by mass of the epoxy resin is, for example, 140 parts by mass or less, and preferably 120 parts by mass or less. The ratio of the colorant such as the red dye with respect to 100 parts by mass of the epoxy resin is, for example, 70 parts by mass or more and 140 parts by mass or less, and preferably 80 parts by mass or more and 120 parts by mass or less.

The second ink layer 37 can be formed, for example, by applying, on the first ink layer 36, a coating material obtained by dissolving or dispersing the above components in any solvent and then drying the coating material.

A thickness of the second ink layer 37 can be arbitrarily set according to, for example, specifications of a thermal transfer printer. The thickness of the second ink layer 37 can be adjusted by an application amount of the second ink layer 37. For example, the application amount of the second ink layer 37 is 0.2 g/m² or more, and preferably 1.0 g/m² or more in terms of solid content per unit area. For example, the application amount of the second ink layer 37 is 7.0 g/m² or less, and preferably 5.0 g/m² or less in terms of solid content per unit area. For example, the application amount of the second ink layer 37 is 0.2 g/m² or more and 7.0 g/m² or less, preferably 1.0 g/m² or more and 5.0 g/m² or less in terms of solid content per unit area.

A specific thickness of the second ink layer 37 (before printing) is, for example, 0.05 μm or more, and preferably 1.0 μm or more. The thickness of the second ink layer 37 is, for example, 7.0 μm or less, and preferably 5.0 μm or less. The thickness of the second ink layer 37 is, for example, 0.05 μm or more and 7.0 μm or less, and preferably 1.0 μm or more and 5.0 μm or less. The thickness of the second ink layer 37 can be checked based on, for example, a scanning electron microscope (SEM) image, a transmission electron microscope (TEM) image, or the like of the ink ribbon 3.

It is noted that, although a description is omitted, a layer such as a separation layer, a middle layer, or the like that assists separation of the first ink layer 36 and the second ink layer 37 may be formed between the first ink layer 36 and the second ink layer 37. The separation layer and the middle layer may be formed of, for example, a thermoplastic elastomer or the like.

The sticking tape 76 includes a base material layer 61, a first adhesive layer 62, a second adhesive layer 63, and a peel-off layer 64. The first adhesive layer 62 is formed on an adhesive surface 65 of the base material layer 61, and the second adhesive layer 63 is formed on a peel-off surface 66 on the opposite side of the adhesive surface 65. The sticking tape 76 is stuck to the print product 56 via the first adhesive layer 62.

### (4) Base Material Layer 61

Examples of the base material layer 61 include a film of a resin such as polysulfone, polystyrene, polyamide, polyimide, polycarbonate, polypropylene, polyester, or triacetate, condenser paper, tissue paper such as glassine paper, cellophane, and the like. Of these materials, a film of polyester such as polyethylene terephthalate (PET) or polyethylene naphthalate is preferable from the viewpoint of mechanical strength, dimensional stability, heat treatment resistance, price, or the like. A thickness of the base material layer 61 can be arbitrarily set according to, for example, specifications of a thermal transfer printer. For example, the thickness of the base material layer 61 is 1 μm or more, and preferably 10 μm or more. For example, the thickness of the base material layer 61 is 100 μm or less, and preferably 50 μm or less. For example, the thickness of the base material layer 61 is 1 μm or more and 100 μm or less, and preferably 10 μm or more and 50 μm or less.

### (5) First Adhesive Layer 62

The first adhesive layer 62 is not particularly limited as long as it is an adhesive layer used for adhesion between films, and examples thereof include acrylic adhesive and rubber-based adhesive. For example, the thickness of the first adhesive layer 62 is 1 μm or more, and preferably 10 μm or more. For example, the thickness of the first adhesive layer 62 is 100 μm or less, and preferably 50 μm or less. For example, the thickness of the first adhesive layer 62 is 1 μm or more and 100 μm or less, and preferably 10 μm or more and 50 μm or less.

### (6) Second Adhesive Layer 63

The second adhesive layer 63 is not particularly limited as long as it is an adhesive layer used for adhesion between films, and such adhesive material as used in the first adhesive layer 62, for example, can be used. For example, the thickness of the second adhesive layer 63 is 1 μm or more, and preferably 10 μm or more. For example, the thickness of the second adhesive layer 63 is 100 μm or less, and preferably 50 μm or less. For example, the thickness of the second adhesive layer 63 is 1 μm or more and 100 μm or less, and preferably 10 μm or more and 50 μm or less.

### (7) Peel-Off Layer 64

When the transfer-completed tape 55A is to be stuck to a target object, the peel-off layer 64 is peeled off from the sticking tape 76 and exposes the second adhesive layer 63. The transfer-completed tape 55A can be stuck to the target object via the exposed second adhesive layer 63. Examples of the peel-off layer 64 include peel-off paper coated with peeling agent such as silicone.

It is noted that as illustrated in FIG. 5C, the sticking tape 76 does not have to include the base material layer 61.

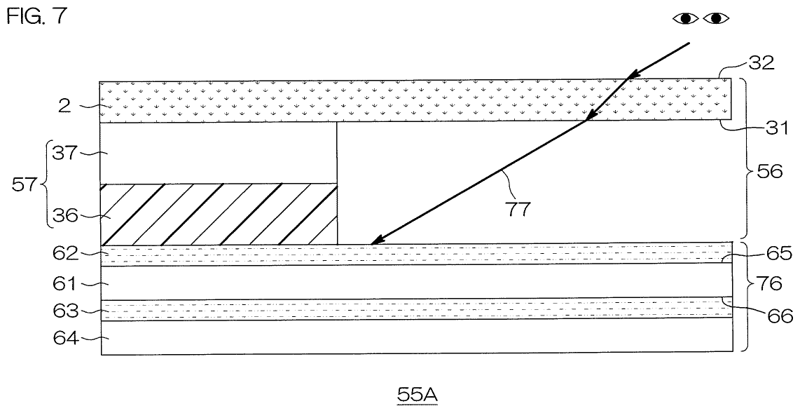

According to the transfer-completed tape 55A that includes the layer configuration as above, the second ink layer 37 is covered with the transparent printer tape 2 (cover film) as illustrated in FIG. 7. Light 77 incident on the second ink layer 37 through the printer tape 2 can thus be refracted through the printer tape 2. As a result, when the second ink layer 37 (front surface side ink layer) is observed obliquely and/or laterally through the printer tape 2, an end portion color of the first ink layer 36 that is hidden by the second ink layer 37 can be made less likely to be observed.

### <Transfer-Completed Tape 55B

With reference to FIG. 5B, the transfer-completed tape 55B includes the printer tape 2 to which a portion of the ink ribbon 3 is transferred, and the sticking tape 76 that is stuck to the printer tape 2. The sticking tape 76 may be referred to as a stick film. FIG. 5B illustrates a cross-section of a portion of the transfer-completed tape 55B to which the laminated body of the first ink layer 36 and the second ink layer 37 has been transferred as a first transfer layer 82, and a cross-section of a portion of the transfer-completed tape 55B to which the second ink layer 37 has been transferred selectively as a second transfer layer 58 is omitted.

In the transfer-completed tape 55B of this preferred embodiment, the sticking tape 76 has a transparent cover film 83 as an example of a transparent film that is stuck to the printer tape 2 with a first adhesive layer 84 therebetween and physically protects the first transfer layer 82 from the outside. Accordingly, in the first transfer layer 82, the first ink layer 36 on a side closer to the cover film 83 is a front surface side ink layer (observation surface side ink layer). As indicated by the open arrow 60, a person can recognize the color of each of the first ink layer 36 and the second ink layer 37 via light transmitted through the cover film 83 and reflected at the first ink layer 36 or the second ink layer 37.

Next, a layer configuration of the transfer-completed tape 55B will be described more specifically.

As mentioned above, the transfer-completed tape 55B is formed by sticking the printer tape 2 and the sticking tape 76 to each other.

In the printer tape 2, a base material layer 80, a first transfer layer 82, a second adhesive layer 85, and a peel-off layer 86 are formed of a print product 81.

### (1) Base Material Layer 80

Examples of the base material layer 80 include a film of a resin such as polysulfone, polystyrene, polyamide, polyimide, polycarbonate, polypropylene, polyester, or triacetate, condenser paper, tissue paper such as glassine paper, cellophane, and the like. Of these materials, a film of polyester such as polyethylene terephthalate (PET) or polyethylene naphthalate is preferable from the viewpoint of mechanical strength, dimensional stability, heat treatment resistance, price, or the like. A thickness of the base material layer 80 can be arbitrarily set according to, for example, specifications of a thermal transfer printer. For example, the thickness of the base material layer 80 is 1 μm or more, and preferably 10 μm or more. For example, the thickness of the base material layer 80 is 100 μm or less, and preferably 50 μm or less. For example, the thickness of the base material layer 80 is 1 μm or more and 100 μm or less, and preferably 10 μm or more and 50 μm or less.

### (2) First Transfer Layer 82

The first transfer layer 82 includes the first ink layer 36 and the second ink layer 37 laminated in this order from the transparent cover film 83 side. Materials of the first ink layer 36 and the second ink layer 37 are the same as the materials of the first ink layer 36 and the second ink layer 37 of the transfer-completed tape 55A.

In the transfer-completed tape 55B, the first ink layer 36 is arranged closer to the transparent cover film 83 than the second ink layer 37. Accordingly, unlike the transfer-completed tape 55A in which the black color of the first ink layer 36 is recognized by transmitting light through the second ink layer 37, the black color of the first ink layer 36 can be recognized without transmitting light through the second ink layer 37. Therefore, it is not necessary to use a dye as the colorant of the second ink layer 37 from the viewpoint of securing the transparency as mentioned above. That is, in the transfer-completed tape 55B, the second ink layer 37 may be colored only with a pigment.

It is noted that, although a description is omitted, a layer such as a separation layer, a middle layer, or the like that assists separation of the first ink layer 36 and the second ink layer 37 may be formed between the first ink layer 36 and the second ink layer 37. The separation layer and the middle layer may be formed of, for example, a thermoplastic elastomer or the like.

On the other hand, the transfer-completed tape 55B is different from the transfer-completed tape 55A in that the first ink layer 36 is a front surface side ink layer (observation surface side ink layer). The front surface side ink layer of the transfer-completed tape 55A is the second ink layer 37. Accordingly, in the transfer-completed tape 55B, the thickness of the first ink layer 36 is preferably equal to the thickness of the second ink layer 37 of the transfer-completed tape 55A. That is, the first ink layer 36 of the transfer-completed tape 55B has a thickness of, for example, 0.05 μm or more, and preferably 1.0 μm or more. The thickness of the second ink layer 37 is, for example, 7.0 μm or less, and preferably 5.0 μm or less. The thickness of the second ink layer 37 is, for example, 0.05 μm or more and 7.0 μm or less, and preferably 1.0 μm or more and 5.0 μm or less.

### (3) Second Adhesive Layer 85

The second adhesive layer 85 is not particularly limited as long as it is an adhesive layer used for adhesion between films, and examples thereof include acrylic adhesive and rubber-based adhesive. For example, the second adhesive layer 85 has a thickness of 1 μm or more, and preferably 10 μm or more. For example, the second adhesive layer 85 has a thickness of 100 μm or less, and preferably 50 μm or less. For example, the second adhesive layer 85 has a thickness of 1 μm or more and 100 μm or less, and preferably 10 μm or more and 50 μm or less.

### (4) Peel-Off Layer 86

When the transfer-completed tape 55B is to be stuck to a target object, the peel-off layer 86 is peeled off from the print product 81 and exposes the second adhesive layer 85. The transfer-completed tape 55B can be stuck to the target object via the exposed second adhesive layer 85. Examples of the peel-off layer 86 include peel-off paper coated with peeling agent such as silicone.

The sticking tape 76 includes the cover film 83 and the first adhesive layer 84.

### (5) Cover Film 83

As the cover film 83, the same material as the printer tape 2 of the transfer-completed tape 55A can be used. Accordingly, the cover film 83 may be formed from a material having the same refractive index as the printer tape 2 of the transfer-completed tape 55A, or may have the same thickness. Further, the cover film 83 may be an unstretched film that has not been subjected to stretching processing in the course of its production, or may be a stretched film that has been subjected to stretching processing such as uniaxial stretching and biaxial stretching. Also, the front surface of the cover film 83 may be subjected to surface finish processing such as glossy finish or matte finish. Furthermore, a peel-off layer or the like that uses silicone to protect the front surface of the cover film 83 before use may be separately formed. These layers may conceptually be part of the cover film 83.

### (6) First Adhesive Layer 84

The first adhesive layer 84 is not particularly limited as long as it is an adhesive layer used for adhesion between films, and examples thereof include acrylic adhesive and rubber-based adhesive. For example, the first adhesive layer 84 has a thickness of 1 μm or more, and preferably 10 μm or more. For example, the first adhesive layer 84 has a thickness of 100 μm or less, and preferably 50 μm or less. For example, the first adhesive layer 84 has a thickness of 1 μm or more and 100 μm or less, and preferably 10 μm or more and 50 μm or less.

The total thickness of the first adhesive layer 84 and the cover film 83 is preferably greater than the thickness of the first ink layer 36. In other words, the first adhesive layer 84 and the cover film 83 are only required to be thinner than the first ink layer 36 alone, and thicker than the first ink layer 36 in total. Furthermore, the total thickness of the first adhesive layer 84 and the cover film 83 is preferably twice or more the thickness of the front surface side ink layer (first ink layer 36).

The first adhesive layer 84 is also interposed between the transfer-completed tape 55B and the first transfer layer 82, and is a layer through which light passes when the printing pattern 44 is observed. Accordingly, the first adhesive layer 84 is preferably transparent. For example, the first adhesive layer 84 has a refractive index of 1.4 or more, preferably 1.5 or more, and more preferably 1.6 or more. The refractive index may be measured by, for example, spectroscopic ellipsometry.

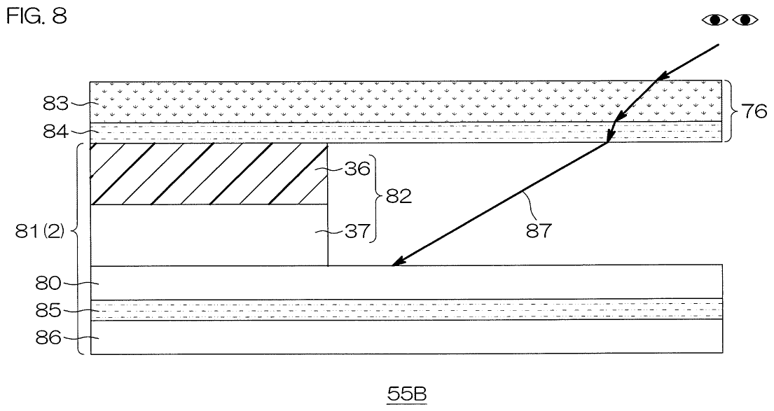

According to the transfer-completed tape 55B that includes the layer configuration as above, the first ink layer 36 is covered with the transparent cover film 83 and the first adhesive layer 84 as illustrated in FIG. 8. Light 87 incident on the first ink layer 36 through the cover film 83 can thus be refracted through the cover film 83 and the first adhesive layer 84. As a result, when the first ink layer 36 (front surface side ink layer) is observed obliquely and/or laterally through the cover film 83, an end portion color of the second ink layer 37 that is hidden by the first ink layer 36 can be made less likely to be observed.

As described above, the above-described preferred embodiment of the present disclosure is illustrative in all respects and should not be construed as limiting, and is intended to include modifications in all respects.

From the description herein and the drawings, the following appended features may be extracted.

### APPENDIX 1-1

A transfer-completed film with a transparent film, a laminated body of a first ink layer and a second ink layer having a different color than the first ink layer, and a base material layer laminated in this order, in which
the first ink layer and the second ink layer form a transfer layer transferred with an ink ribbon that includes a laminated body of the first ink layer and the second ink layer.

### APPENDIX 1-2

The transfer-completed film according to appendix 1-1, in which the transfer layer is formed by hot-melt transfer.

### APPENDIX 1-3

The transfer-completed film according to appendix 1-1 or 1-2, in which the laminated body of the first ink layer and the second ink layer includes a front surface side ink layer that is close to the transparent film and a back surface side ink layer opposite thereto, and
the transparent film is thicker than the front surface side ink layer.

### APPENDIX 1-4

The transfer-completed film according to any one of appendices 1-1 to 1-3, in which the transparent film has a refractive index of 1.4 or more as measured by spectroscopic ellipsometry.

### APPENDIX 1-5

The transfer-completed film according to any one of appendices 1-1 to 1-4, including:
a print product with the transparent film, the second ink layer, and the first ink layer laminated in this order; and
a stick layer that includes a first adhesive layer laminated on the print product on the first ink layer side and the base material layer stuck to the print product with the first adhesive layer therebetween.

### APPENDIX 1-6

The transfer-completed film according to appendix 1-5, in which the stick layer further includes a second adhesive layer laminated on the base material layer on a side opposite to the first adhesive layer and a peel-off layer laminated on the base material layer with the second adhesive layer therebetween.

### APPENDIX 1-7

The transfer-completed film according to any one of appendices 1-1 to 1-4, including:
a stick layer that includes the transparent film and a first adhesive layer laminated on a surface of the transparent film; and
a print product that includes the first ink layer stuck to the transparent film with the first adhesive layer therebetween, and the second ink layer, the base material layer, and a second adhesive layer laminated in this order on the first ink layer.

### APPENDIX 1-8

The transfer-completed film according to appendix 1-7, in which the print product further includes a peel-off layer laminated on the base material layer with the second adhesive layer therebetween.

### APPENDIX 1-9

The transfer-completed film according to any one of appendices 1-1 to 1-8, in which the transfer-completed film is a transfer-completed tape formed in a tape shape.

### APPENDIX 1-10

A transfer-completed film producing method including:
a step of forming a print product that has a transfer layer by transferring an ink ribbon that includes a laminated body of a first ink layer and a second ink layer having a different color than the first ink layer on a first surface of a transparent film that has the first surface and a second surface such that the second ink layer is on the first surface side; and
a step of sticking a stick layer that includes a first adhesive layer and a base material layer to the print product by sticking the first adhesive layer to the transfer layer.

### APPENDIX 1-11

A transfer-completed film producing method including:
a step of forming a print product that has a transfer layer by transferring an ink ribbon that includes a laminated body of a first ink layer and a second ink layer having a different color than the first ink layer on a first surface of a base material layer that has the first surface and a second surface such that the second ink layer is on the first surface side; and
a step of sticking a stick layer that includes a first adhesive layer and a transparent film to the print product by sticking the first adhesive layer to the transfer layer.

### Examples

Hereinafter, the present disclosure will be further described based on a plurality of samples, but the configuration of the present disclosure is not limited to these examples.

### [Coating Material (1) for Black Colored Layer]

Individual components illustrated in Table 1 below were dissolved in a mixed solvent of toluene and methyl ethyl ketone (MEK) at a mass ratio of 1/4 to prepare a coating material (1) for the black colored layer having a solid content concentration of 22.5 mass %. A ratio of the active component in the acrylic adhesive was 80 parts by mass with respect to 100 parts by mass of the epoxy resin.

TABLE 1

| Ingredient | Parts by mass |
|---|---|
| Epoxy resin | 100 |
| Acrylic adhesive | 200 |
| Tackifier | 28.3 |
| Carbon black | 166.7 |

The respective components in the table are as follows.
Epoxy resin: JER1007 [basic solid type, softening point (ring-and-ball method): 128° C., number average molecular weight Mn: about 2,900] manufactured by Mitsubishi Chemical Group
Acrylic adhesive: AS-665 [solid content concentration: 40 mass %] manufactured by LION SPECIALTY CHEMICALS CO., LTD.
Tackifier: Terpene phenolic resin, YS POLYSTER T80 (softening point: 80±5° C.) manufactured by YASUHARA CHEMICAL Co., Ltd.
Carbon black: MA100 Powder form [LFF, DBP absorption number: 100 cm³/100 g] manufactured by Mitsubishi Chemical Group

### [Coating Material (1) for Red Colored Layer]

Individual components shown in Table 2 below were dissolved in a mixed solvent of toluene and methyl ethyl ketone (MEK) at a mass ratio of 1/4 to prepare a coating material (1) for the coating material (1) for red colored layer having a solid content concentration of 28 mass %.

TABLE 2

| Ingredient | Parts by mass |
|---|---|
| Epoxy resin | 100 |
| Wax | 7.1 |
| Red pigment | 92.9 |

The respective components in the table are as follows.

Epoxy resin: JER1004 [Basic solid type, softening point (ring and ball method): 97° C., number average molecular weight Mn: about 1650] manufactured by Mitsubishi Chemical Corporation

Low-melting-point wax: carnauba wax No. 2 powder (melting point: 80 to 86° C.) manufactured by Toyochem Co., Ltd.

Red colorant: red dye VALIFAST RED1320 (Onium salt of C.I. BASIC RED 1 and azo dye) manufactured by Orient Chemical Industries Co., Ltd.

### [Samples 1 to 9]

### (1) Production of Ink Ribbon (Thermal Transfer Recording Medium)

First, a PET film having a thickness of 4.5 μm was prepared as a base material layer. Next, a back surface layer made of a silicone-based resin and having a solid content of 0.1 g/m² per unit area was formed on a surface (back surface) of the base material layer opposite to a front surface on which a transfer layer was to be formed. Next, the coating material (1) for the black colored layer which was previously prepared was applied to the front surface of the base material layer and then dried to form a black colored layer having a solid content of 2.5 g/m² per unit area. The thickness of the black colored layer was 2.5 μm. Next, the coating material (1) for the middle layer which was previously prepared was applied to the black colored layer and then dried to form a middle layer having a solid content per unit area of 2.5 g/m² and thereby produce an ink ribbon. The thickness of the red colored layer was 2.5 μm. Tables 4 to 6 below show the composition of each layer of ink ribbons obtained with samples 1 to 9. It is noted that in Sample 2, a red colored layer having a solid content per unit area of 7 g/m² was formed, and a red colored layer having a thickness of 7 μm was formed.

### (2) Production of Transfer-Completed Film

### <Sample 1>

The ink ribbon obtained above was wound in a roll shape and set in a thermal transfer printer [Prototype Printer manufactured by BROTHER INDUSTRIES, LTD.]. Main specifications of the thermal transfer printer are as follows.

| <Resolution> | 300 dpi line thermal head | |
|---|---|---|
| <Resistance value of the heating body> | 1830 | Ω |
| <Transfer Load> | 30 | N/2 inch |
| <Transport speed> | 20 | mm/sec |
| <Peel-off distance> | 110 | mm |

Next, an energy value which was set in advance in the thermal transfer printer and applied to a thermal head was set to 100 (low temperature, black) in an environment with an outside temperature of 25° C. Then, a barcode was recorded on a surface of a PET film [Lumirror (registered trademark) #6-S10 manufactured by Toray Industries, Inc., thickness 6 μm, refractive index 1.66] as a transparent base material film under the condition of a printing speed of 5 inch/sec. After the recording, a stick film [Polyester film (white, glossy), FR1415-50PET manufactured by LINTEC Corporation] provided with an adhesive layer was laminated on the base material film such as to cover the barcode. Consequently, a transfer-completed film was obtained with a laminated body of the red colored layer and the black colored layer formed as a transfer layer such that the red colored layer was on the base material film side. In the transfer-completed film, the base material film serves as a cover film that covers the front surface side of the transfer layer. It is noted that the refractive index of the PET film was measured using a rotation compensator type high-speed spectroscopic ellipsometer M-2000 (registered trademark) manufactured by J.A.Woollam Japan. The incident angle at the time of measurement was set to 500 to 70°.

### <Sample 2>

A transfer-completed film was prepared in the same manner as in Sample 1 except that an ink ribbon with a red colored layer having a thickness of 7 μm was used.

### <Sample 3>

A transfer-completed film was prepared in the same manner as in Sample 1 except that a PE film [LIX (registered trademark) film L4102 manufactured by TOYOBO Co., Ltd., refractive index 1.53] having a thickness of 25 μm was used as the transparent base material film (cover film).

### <Sample 4>

A transfer-completed film was prepared in the same manner as in Sample 1 except that a PC film [PURE-ACE (registered trademark) grade D manufactured by TEIJIN LIMITED, refractive index 1.58] having a thickness of 25 μm was used as the transparent base material film (cover film).

### <Sample 5>

A transfer-completed film was prepared in the same manner as in Sample 1 except that a biaxially oriented polystyrene film [OPS (registered trademark) film manufactured by Asahi Kasei Corp., refractive index 1.47] having a thickness of 14 μm was used as the transparent base material film (cover film).

### <Sample 6>

A transfer-completed film was prepared in the same manner as in Sample 1 except that a PTFE film [NITOFLON (registered trademark) No. 920UL manufactured by Nitto Denko Corporation, refractive index 1.35] having a thickness of 20 μm was used as the transparent base material film (cover film).

### <Sample 7>

The ink ribbon obtained above was wound in a roll shape and set in a thermal transfer printer of the same specifications as described above. Next, an energy value which was set in advance in the thermal transfer printer and applied to a thermal head was set to 100 (low temperature, black) in an environment with an outside temperature of 25° C. Then, a barcode was recorded on a surface of a label material for variable information printing [Polyester film (white, glossy), FR1415-50 manufactured by LINTEC Corporation] under the condition of a printing speed of 5 inch/sec. After the recording, a stick film composed of a transparent PET film [Lumirror (registered trademark) #2-F51 manufactured by Toray Industries, Inc., thickness 2 μm, refractive index 1.57] provided with an adhesive layer [QUICKMASTER (registered trademark) SPS-1090NT manufactured by DIC Corporation, refractive index 1.50] having a thickness of 2 μm was laminated on the label material such as to cover the barcode. Consequently, a transfer-completed film was obtained with a laminated body of the red colored layer and the black colored layer formed as a transfer layer such that the black colored layer was on the base material film side. In the transfer-completed film, the stick film serves as a cover film that covers the front surface side of the transfer layer. It is noted that the refractive index of the PET film was measured using a rotation compensator type high-speed spectroscopic ellipsometer M-2000 (registered trademark) manufactured by J.A.Woollam Japan. The incident angle at the time of measurement was set to 500 to 70°.

### <Sample 8>

A transfer-completed film was prepared in the same manner as in Sample 7 except that an adhesive layer [QUICKMASTER (registered trademark) SPS-1090NT manufactured by DIC Corporation, refractive index 1.50] having a thickness of 4.5 μm was used as the adhesive layer of the stick film (cover film).

### <Sample 9>

A transfer-completed film was prepared in the same manner as in Sample 7 except that the stick film was not laminated on the label material.

### (2) Evaluation

### (2-1) Oblique Observation

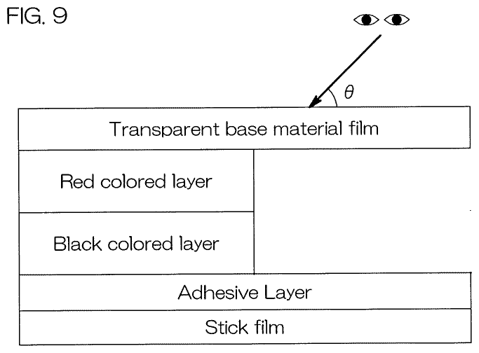

As illustrated in FIG. 9, the change in the color of the print product that can be visually recognized was evaluated by changing the observation point from an angle θ of 10° to 90° with respect to the front surface of the transfer-completed film obtained in Samples 1 to 9. Evaluation criteria of the oblique observation are as follows. The results are shown in Tables 3 and 4 below.
∘: Even when the angle θ is 10°, it seems the print of the color of the front surface side ink layer.
Δ: When the angle θ is less than 450, an end portion color of the ink layer covered with the front surface side ink layer is visible.
x: When the angle θ is less than 70°, an end portion color of the ink layer covered with the front surface side ink layer is visible.

TABLE 3

| | Sample | Sample | Sample | Sample | Sample |
|---|---|---|---|---|---|
| | 1 | 2 | 3 | 4 | 5 |
| Thickness of | 2.5 | 7 | 2.5 | 2.5 | 2.5 |
| front surface | | | | | |
| side ink | | | | | |
| layer (μm) | | | | | |
| Thickness of | 6 | 6 | 25 | 25 | 14 |
| cover film | | | | | |
| (μm) | | | | | |
| Material of | PET | PET | PE | PC | PS |
| cover film | | | | | |
| Refractive | 1.66 | 1.57 | 1.53 | 1.58 | 1.47 |
| index of | | | | | |
| cover film | | | | | |
| Thickness of | — | — | — | — | — |
| front surface | | | | | |
| side adhesive | | | | | |
| layer (μm) | | | | | |
| Oblique | ∘ | Δ | ∘ | ∘ | ∘ |
| observation | | | | | |

TABLE 4

| | Sample 6 | Sample 7 | Sample 8 | Sample 9 |
|---|---|---|---|---|
| Thickness of | 2.5 | 2.5 | 2.5 | 2.5 |
| front surface | | | | |
| side ink layer | | | | |
| (μm) | | | | |
| Thickness of | 20 | 2 | 2 | — |
| cover film (μm) | | | | |
| Material of cover film | PTFE | PET | PET | — |
| Refractive index | 1.35 | 1.57 | 1.57 | — |
| of cover film | | | | |
| Thickness of | — | 2 | 4.5 | — |
| front surface | | | | |
| side adhesive | | | | |
| layer (μm) | | | | |
| Oblique | Δ | Δ | ∘ | x |
| observation | | | | |

Based on the comparison between Samples 1 to 8 and Sample 9, when a transparent cover film is provided that covers the front surface side ink layer, an end portion color of the ink layer covered with the front surface side ink layer was not observed at least when the angle θ was 45° or more. Also, based on the comparison between Sample 1 and Sample 2, it was found that, even when a cover film is provided, higher evaluation can be obtained when the thickness of the cover film is greater than the thickness of the front surface side ink layer. On the other hand, based on the results of Sample 8, it was found that, even when the thickness of the cover film is smaller than the thickness of the front surface side ink layer, an end portion color suppressing effect can be enhanced if the total thickness of the cover film and the adhesive layer is twice or more the thickness of the front surface side ink layer.

Also, based on the results of Samples 1 and 8 and Samples 3 to 6, it was found that, as long as the cover film is a PET film, the total thickness of the cover film and the adhesive layer can be made less than 10 μm while sufficiently realizing the end portion color suppressing effect. Thus, in Samples 1 and 8, the transfer-completed film can be favorably stuck even to a complicatedly curved surface.

Reference Signs List

| | |
|---|---|
| 2 | printer tape |
| 3 | ink ribbon |
| 35 | base material layer |
| 36 | first ink layer |
| 37 | second ink layer |
| 42 | first portion |
| 43 | second portion |
| 44 | printing pattern |
| 45 | red pattern |
| 46 | black pattern |
| 48 | base material layer |
| 55 | transfer-completed tape |
| 55A | transfer-completed tape |
| 55B | transfer-completed tape |
| 56 | print product |
| 57 | first transfer layer |
| 61 | base material layer |
| 62 | first adhesive layer |
| 63 | second adhesive layer |
| 64 | peel-off layer |
| 76 | sticking tape |
| 80 | base material layer |
| 81 | print product |
| 82 | first transfer layer |
| 83 | cover film |
| 84 | first adhesive layer |
| 85 | second adhesive layer |
| 86 | peel-off layer |

1. A transfer-completed film with a transparent film, a laminated body of a first ink layer and a second ink layer having a different color than the first ink layer, and a base material layer laminated in this order, wherein
the first ink layer and the second ink layer form a transfer layer transferred with an ink ribbon that includes the laminated body of the first ink layer and the second ink layer.

2. The transfer-completed film according to claim 1, wherein the transfer layer is formed by hot-melt transfer.

3. The transfer-completed film according to claim 1, wherein the laminated body of the first ink layer and the second ink layer includes a front surface side ink layer that is close to the transparent film and a back surface side ink layer opposite thereto, and the transparent film is thicker than the front surface side ink layer.

4. The transfer-completed film according to claim 1, wherein the transparent film has a refractive index of 1.4 or more as measured by spectroscopic ellipsometry.

5. The transfer-completed film according to claim 1, comprising:
a print product with the transparent film, the second ink layer, and the first ink layer laminated in this order; and
a stick layer that includes a first adhesive layer laminated on the print product on the first ink layer side and the base material layer stuck to the print product with the first adhesive layer therebetween.

6. The transfer-completed film according to claim 5, wherein the stick layer further includes a second adhesive layer laminated on the base material layer on a side opposite to the first adhesive layer and a peel-off layer laminated on the base material layer with the second adhesive layer therebetween.

7. The transfer-completed film according to claim 1, comprising:
a stick layer that includes the transparent film and a first adhesive layer laminated on a surface of the transparent film; and
a print product that includes the first ink layer stuck to the transparent film with the first adhesive layer therebetween, and the second ink layer, the base material layer, and a second adhesive layer laminated in this order on the first ink layer.

8. The transfer-completed film according to claim 7, wherein the print product further includes a peel-off layer laminated on the base material layer with the second adhesive layer therebetween.

9. The transfer-completed film according to claim 1, wherein the transfer-completed film is a transfer-completed tape formed in a tape shape.

10. A transfer-completed film producing method comprising:
a step of forming a print product that has a transfer layer by transferring an ink ribbon that includes a laminated body of a first ink layer and a second ink layer having a different color than the first ink layer on a first surface of a transparent film that has the first surface and a second surface such that the second ink layer is on the first surface side; and
a step of sticking a stick layer that includes a first adhesive layer and a base material layer to the print product by sticking the first adhesive layer to the transfer layer.

11. A transfer-completed film producing method comprising:
a step of forming a print product that has a transfer layer by transferring an ink ribbon that includes a laminated body of a first ink layer and a second ink layer having a different color than the first ink layer on a first surface of a base material layer that has the first surface and a second surface such that the second ink layer is on the first surface side; and
a step of sticking a stick layer that includes a first adhesive layer and a transparent film to the print product by sticking the first adhesive layer to the transfer layer.
